(19) United States
(12) Patent Application Publication
(10) Pub. No.: US 2013/0332269 A1
(43) Pub. Date: Dec. 12, 2013

(54) METHOD AND APPARATUS FOR ADVERTISEMENT DELIVERY

(71) Applicant: YAHOO JAPAN CORPORATION, Tokyo (JP)

(72) Inventor: Kiyoshi SASAKI, Tokyo (JP)

(73) Assignee: YAHOO JAPAN CORPORATION, Tokyo (JP)

(21) Appl. No.: 13/736,408

(22) Filed: Jan. 8, 2013

(30) Foreign Application Priority Data
Jun. 12, 2012 (JP) 2012-133294

(51) Int. Cl. G06Q 30/02

(52) U.S. Cl. CPC G06Q 30/0251
USPC 705/14.49

(57) ABSTRACT

Provided is an advertisement delivery method for delivering an advertisement for causing a user terminal, which transmitted an access request to a web site via a link set in an advertisement, to transmit an access request to the web site again. The advertisement delivery method includes acquiring, by a computer, a behavior pattern of the user terminal in the web site, and delivering to the user terminal, by the computer, a different advertisement depending on the behavior pattern by setting a link to the web site in the different advertisement.

### CROSS-REFERENCE TO RELATED APPLICATION

This application is based upon and claims the benefit of priority from Japanese Patent Application No. 2012-133294, filed on Jun. 12, 2012, the entire contents of which are incorporated herein by reference.

### BACKGROUND OF THE INVENTION

1. Field of the Invention

The present invention relates to an advertisement delivery apparatus and an advertisement delivery method.

2. Description of the Related Art

Retargeting advertising is performed in which an advertisement of a landing page visited by a user is displayed again, thereby prompting the user to revisit the landing page. Japanese Laid-open Patent Publication No. 2012-94097 describes a method in which, even when the number of audiences specified by retargeting advertising is small, an advertisement is displayed to audiences similar to the specified ones.

However, in the retargeting, users are repeatedly shown the same advertisement, and thus, users may get tired thereof. Therefore, there is a possibility that an advertisement effect is reduced depending on users.

### SUMMARY OF THE INVENTION

According to one aspect of the embodiments, an advertisement delivery apparatus delivers an advertisement for causing a user terminal, which transmitted an access request to a web site via a link set in an advertisement, to transmit an access request to the web site again. The advertisement delivery apparatus includes a behavior pattern acquiring unit that acquires a behavior pattern of the user terminal in the web site, and an advertisement delivery unit that delivers to the user terminal a different advertisement depending on the behavior pattern by setting a link to the web site in the different advertisement.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram illustrating an overall configuration of an advertisement delivery system according to an embodiment of the present invention;

FIG. 2 is a diagram illustrating a hardware configuration example of a Web server illustrated in FIG. 1;

FIG. 3 is a diagram illustrating a software configuration example of the Web server illustrated in FIG. 1;

FIG. 4 is a diagram illustrating a configuration example of an advertisement database illustrated in FIG. 3;

FIG. 5 is a diagram illustrating a configuration example of a behavior pattern database illustrated in FIG. 3;

FIG. 6 is a diagram illustrating a flow of a process performed by an advertisement delivery unit illustrated in FIG. 3;

FIG. 7 is a diagram illustrating an example of a screen on which a Web page is displayed in a user terminal according to the embodiment;

FIG. 8 is a diagram illustrating an example of a landing page provided by an LP providing server illustrated in FIG. 1;

FIG. 9 is a diagram illustrating an example of a screen displayed when a user accesses the Web server again according to the embodiment; and

FIG. 10 is a diagram illustrating an example of a landing page displayed when a user revisits by retargeting according to the embodiment.

### DESCRIPTION OF EMBODIMENTS

### ——Overview——

An advertisement delivery system according to an embodiment of the present invention performs a retargeting advertising. The retargeting advertising prompts a user, who has accessed a web site (hereinafter referred to as landing site) of an advertiser by clicking an advertisement, to revisit the web site by showing the advertisement to the user again. In particular, the advertisement delivery system according to the embodiment changes an advertisement shown again depending on the behaviors of the user in the web site of the advertiser.

In the present embodiment, the following circumstances are assumed. A user accesses a Web server and views a Web page such as a top page, and finds an advertisement displayed in the Web page. When the user clicks the advertisement and accesses a landing site of an advertiser, a questionnaire is displayed in the landing site, and the user responds to the questionnaire. When the user accesses the same web server again after several hours or several days, retargeting advertising is performed, namely, the advertisement the user clicked before is displayed again. According to the present embodiment, a different advertisement may be displayed according to the response of the user to the questionnaire.

### ——System Configuration——

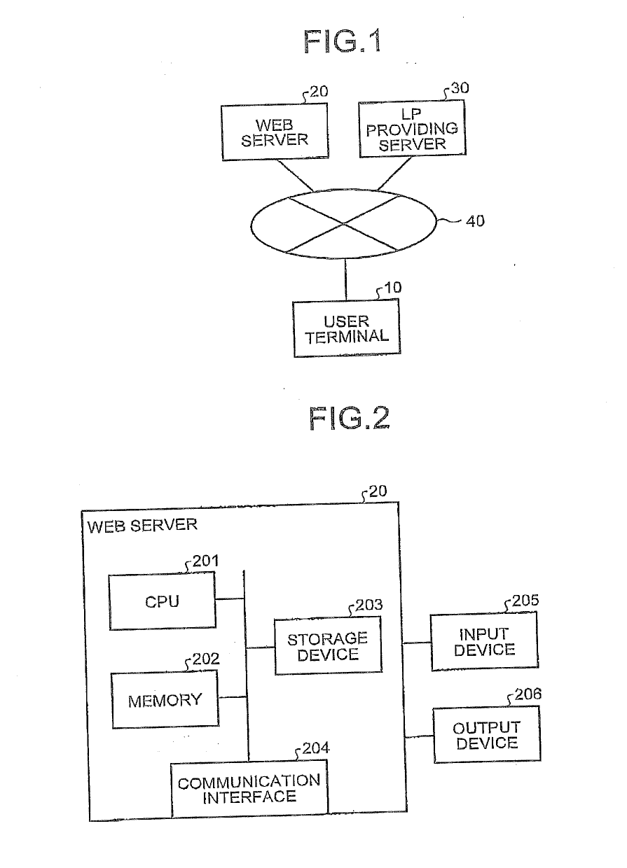

FIG. 1 is a diagram illustrating an overall configuration of the advertisement delivery system according to an embodiment of the present invention. The advertisement delivery system of the present embodiment includes a Web server 20 and an LP (Landing Page) providing server 30. A user terminal 10 can access the Web server 20 and the LP providing server 30 via a communication network 40. The communication network 40 is, for example, the Internet, a WAN (Wide Area Network), a LAN (Local Area Network), a VAN (Value Added Network), or the like, built by a public telephone network, a mobile phone network, a wireless communication channel, Ethernet (registered trademark), and the like. In the present embodiment, the communication network 40 performs communication using TCP/IP.

The user terminal 10 is for example, a portable telephone terminal or a smart phone, or a computer such as a tablet computer, a laptop computer, or a personal computer, which is operated by a user. A Web browser is operated in the user terminal 10, and the user accesses the Web server 20 by HTTP (HyperText Transfer Protocol) using the Web browser. In FIG. 1, only a single user terminal 10 is illustrated, but there may be a plurality of user terminals 10 for each user.

The Web server 20 is a computer such as, for example, a personal computer or a workstation which provides contents such as a Web page described with HTML (HyperText Markup Language), XML (eXtensible Markup Language), or the like, still image data, moving image data, and sound data. The Web server 20 may be a single computer or may be realized by a plurality of computers. The Web server 20 provides an advertisement embedded in the Web page. The advertisement may be provided as a variety of data such as an image, a moving image, and sound. Hereinafter, for simplicity of description, it is assumed that the Web server 20 embeds an image advertisement in a Web page described with HTML.

The LP providing server 30 is a computer such as, for example, a personal computer or a workstation which provides a Web page (hereinafter, also referred to as a landing page which is also indicated by LP) which provides information regarding merchandise such as goods or services related to an advertisement. Landing page is displayed when an advertisement embedded in a Web page provided by the Web server 20 is clicked. In FIG. 1, only a single LP providing server 30 is illustrated, but the LP providing server 30 is provided for each landing site. Note that, the landing page is one of the Web pages provided in the landing site, and is a Web page which is initially displayed when an advertisement is clicked by the user terminal 10 to access the landing site.

### ——Hardware——

FIG. 2 is a diagram illustrating a hardware configuration example of the Web server 20. The Web server 20 includes a CPU 201, a memory 202, a storage device 203, a communication interface 204, an input device 205, and an output device 206. The storage device 203 is, for example, a hard disk drive, a solid state drive, or a flash memory which stores a variety of data or programs. The CPU 201 realizes various functions by reading out the programs stored in the storage device 203, installing the programs on the memory 202 and executing the programs. The communication interface 204 is an interface for connection to the communication network 40, and is, for example, an adaptor for connection to an Ethernet®, a modem for connection to a public telephone network, a wireless communication device for connection to a wireless communication network, or the like. The input device 205 is, for example, a keyboard, a mouse, a track ball, a touch panel, a microphone, or the like, by which data is input. The output device 206 is, for example, a display, a printer, a speaker, or the like, which outputs data. The Web server 20 may include a plurality of input devices 205 and output devices 206.

### ——Software——

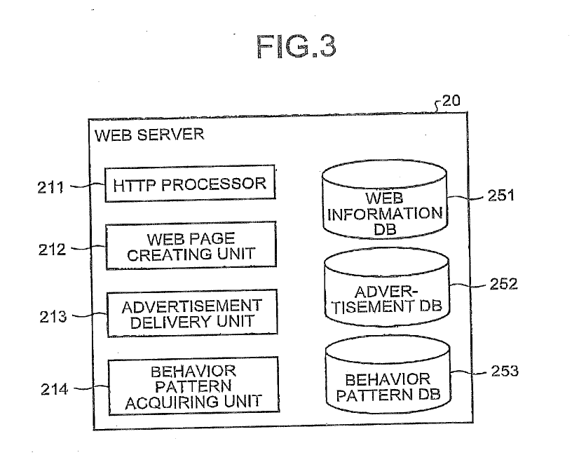

FIG. 3 is a diagram illustrating a software configuration example of the Web server 20. The Web server 20 includes processors such as a HTTP processor 211, a Web page creating unit 212, an advertisement delivery unit 213, and a behavior pattern acquiring unit 214, and storage units such as a Web information database (DB) 251, an advertisement database (DB) 252, and a behavior pattern database (DB) 253. Each of the processors is realized by the CPU 201 included in the Web server 20, reading out the programs stored in the storage device 203 to the memory 202, and executing the programs.

### ——Description of Storage——

The Web information database 251 stores information (hereinafter, referred to as Web information) for creating a Web page. The Web information is, for example, a file described with HTML, a program file which stores a program executable by the CGI (Common Gateway Interface), or an image file. The Web information database 251 may be realized using, for example, directories or folders of a file system provided by an operating system which is operated in the Web server 20. It is assumed that the Web information database 251 manages a variety of contents according to a technique employed by general Web servers to manage the contents.

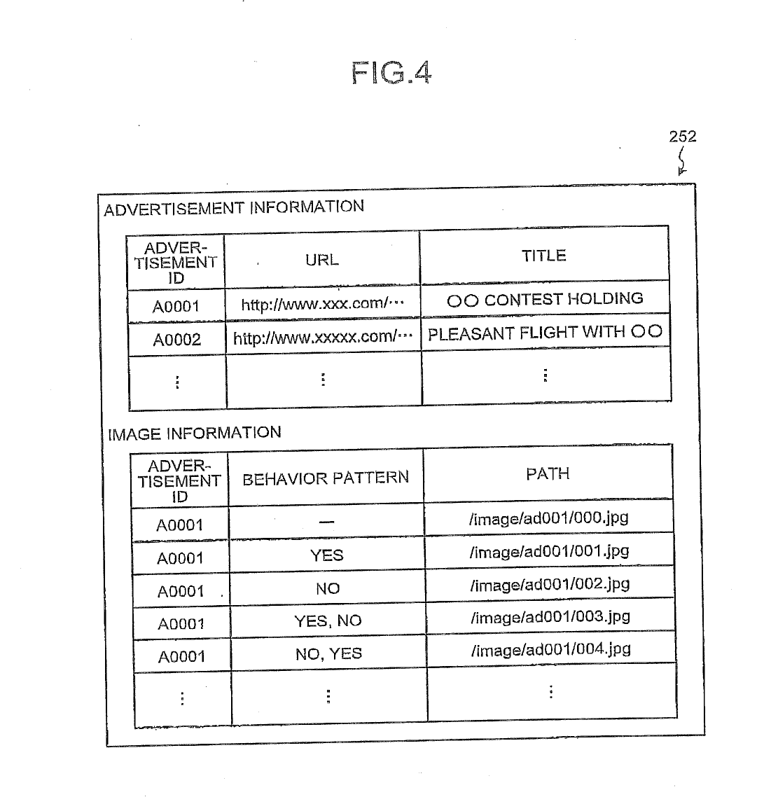

The advertisement database 252 stores information regarding an advertisement (hereinafter, referred to as advertisement information). FIG. 4 is a diagram illustrating a configuration example of the advertisement database 252. In the present embodiment, an advertisement is assumed to be embedded in a Web page as an image, and the advertisement database 252 is assumed to store advertisement information and image information regarding an image (hereinafter, referred to as advertisement image) which is displayed as en advertisement.

The advertisement information includes an advertisement ID which is identification information of the advertisement, a URL (Uniform Resource Locator) indicating a landing page of the advertisement, and a title of the advertisement. The advertisement information may include an explanation of the advertisement in addition to the title. As described later, an advertisement to be delivered is selected according to a title.

The image information includes en advertisement ID, a behavior pattern of a user in a landing site, and a path of an advertisement image. In FIG. 4, a behavior pattern of “-” indicates that a user does not access a landing site or that the user accesses the landing site but does not carry out any action. It is assumed that, for the advertisement whose advertisement information is registered in the advertisement database 252, at least image information of a behavior pattern of “-” is registered in the advertisement database 252. The path is information for specifying a file of an image stored in the Web information database 251. When an advertisement image is stored in another server different from the Web server 20, a URL to the advertisement image stored in the other server may be set as the path.

As described later, the behavior pattern is a pattern of a response to a questionnaire consisting of either-or questions. An advertisement image corresponding to a behavior pattern other than “-” includes a message from an advertiser corresponding to the user's response to the questionnaire.

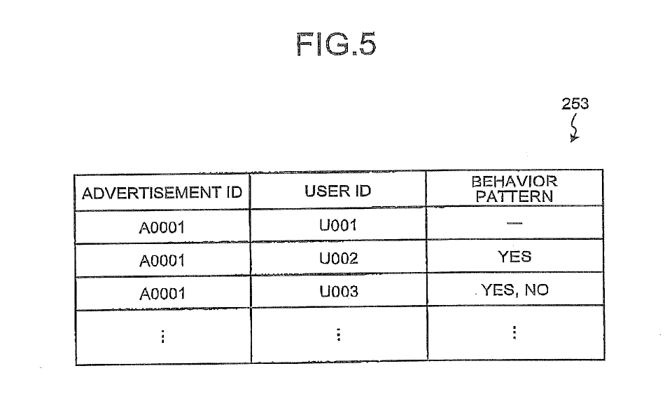

The behavior pattern database 253 stores information (hereinafter, referred to as behavior pattern information) including a behavior pattern of a user in a landing site. FIG. 5 is a diagram illustrating a configuration example of the behavior pattern database 253. The behavior pattern information includes a user ID indicating a user who accesses a landing page of an advertisement indicated by an advertisement ID, and a behavior pattern of the user in the landing site. The user ID and the behavior pattern are associated with the advertisement ID. The user ID may be identification information of the user terminal 10 (or a browser operated on the user terminal 10) which is issued to the user terminal 10 and is set in a cookie. Alternatively, the user ID may be an ID issued by an operator of the Web server 20 to a user, who operates the user terminal 10, to identify the user. In the present embodiment, it is assumed that the user ID is identification information issued to a user who operates the user terminal 10, and the user logs in to the Web server 20 by operating the user terminal 10. The behavior pattern is a response pattern of a user to a questionnaire. In the present embodiment, as described later, the LP providing server 30 issues a questionnaire of either-or questions to a user to receive “YES” or “NO” answer twice. The behavior pattern is a response pattern of the user to the questionnaire. Therefore, there are four types of behavior pattern. When the user returns only one answer, the behavior pattern is “YES” or “NO”. When the user returns two answers, the behavior pattern is either “YES, NO” or “NO, YES”. A path to an advertisement image for each of the four behavior patterns is stored (see FIG. 4). For a user who does not access the landing site or a user who does not make any actions in the landing site, behavior pattern information including the behavior pattern “-” is registered.

### ——Description of Processors——

The behavior pattern acquiring unit 214 acquires a behavior pattern of a user and registers the acquired behavior pattern in the behavior pattern database 253. The behavior pattern acquiring unit 214 acquires a behavior pattern of a user from the LP providing server 30 which provides a landing page of an advertisement. As described later, in the present embodiment, the behavior pattern acquiring unit 214 acquires a behavior pattern of the user terminal 10 using a program (hereinafter, referred to as a beacon) which is included in a Web page for displaying a landing page created by the LP providing server 30.

The HTTP processor 211 performs an HTTP process. The HTTP process performed by the HTTP processor 211 is assumed as a process in a general web server.

The HTTP processor 211 receives an HTTP request transmitted from the user terminal 10. The HTTP request includes a user ID for specifying a user of the user terminal 10. When the HTTP request designates a predetermined URL (hereinafter, referred to as a redirect URL) corresponding to an advertisement ID, the HTTP processor 211 reads advertisement information corresponding to the advertisement ID from the advertisement database 252 and sends a response, which designates a URL included in the read advertisement information as a redirect destination, to the user terminal 10. Thereby, the user terminal 10 is redirected to the landing page. A log indicating that an advertisement is clicked may be recorded at this timing.

On the other hand, when the HTTP request designates a URL which indicates a Web page other than the redirect URL, the HTTP processor 211 calls the Web page creating unit 212 to create a Web page, and sends the Web page created by the Web page creating unit 212 to the user terminal 10. A log indicating that an advertisement is delivered may be recorded at this timing.

The Web page creating unit 212 creates a Web page. The Web page creating unit 212 reads Web information stored in the Web information database 251, and creates a Web page based on the read Web information. The Web page creating unit 212 may create a Web page using a process performed by a general Web server. In addition, the Web page creating unit 212 calls the advertisement delivery unit 213 to insert an advertisement into the Web page.

The advertisement delivery unit 213 delivers an advertisement to be displayed in a Web page. In the present embodiment, the advertisement delivery unit 213 embeds an advertisement image, in which a link to a redirect URL is set, in the Web page created by the Web page creating unit 212, thereby delivering the advertisement.

### ——Description of Advertisement Delivery Process——

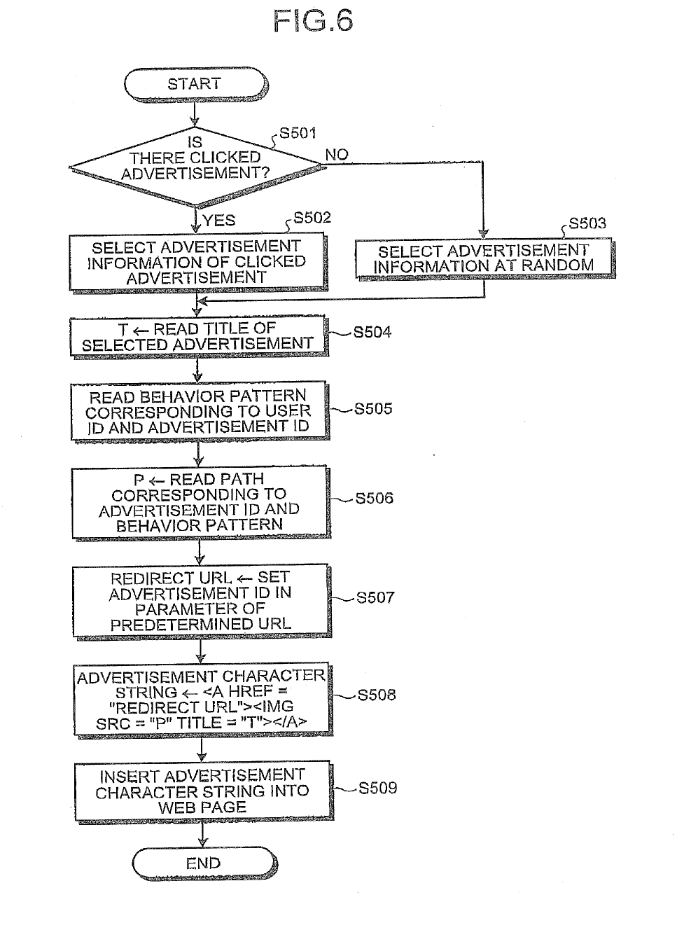

FIG. 6 is a diagram illustrating a flow of the process performed by the advertisement delivery unit 213.

First, the advertisement delivery unit 213 determines whether or not there is an advertisement clicked by a user in the past (S501). The advertisement delivery unit 213 may determine whether or not there is a clicked advertisement depending on whether or not behavior pattern information where a behavior pattern corresponding to a user ID set in an HTTP request is not “-” is registered in the behavior pattern database 253.

When there is a clicked advertisement, that is, when there is behavior pattern information including a behavior pattern other than “-”, corresponding to the user ID (S501: YES), the advertisement delivery unit 213 selects advertisement information corresponding to an advertisement ID included in one piece of behavior pattern information including the behavior pattern other than “-” (S502). Thereby, a retargeting advertising is performed.

When there is no clicked advertisement (S501; NO), the advertisement delivery unit 213 selects one piece of advertisement information at random (S503).

Next, the advertisement delivery unit 213 reads a title of the selected advertisement information from the advertisement database 252 so as to be set to T (S504). The advertisement delivery unit 213 reads the user ID set in the HTTP request and a behavior pattern corresponding to the advertisement ID of the advertisement information from the behavior pattern database 253 (S505). The advertisement delivery unit 213 reads a path of image information corresponding to the read behavior pattern and the advertisement ID of the advertisement information from the advertisement database 252 so as to be set to P (S506). The advertisement delivery unit 213 creates a redirect URL where the advertisement ID included in the advertisement information is set in a parameter of a predetermined URL (S507). The redirect URL may be in a form of, for example, www.foobar.com/ad?id=xxx.

The advertisement delivery unit 213 sets a title of the advertisement information in an image tag to the read path as an attribute, and sets a link tag to the redirect URL to create an advertisement character string (S508). The advertisement character string may be in a form of, for example, “<a href=“http://www.foobar.com/ad?id=A0001”><img src=”/image/ad001/000.jpg title=“OO contest holding”/></a>”. The advertisement delivery unit 213 inserts the created advertisement character string in the Web page created by the Web page creating unit 212 (S509).

### ——Advantageous Effects——

As described above, different advertisement images can be delivered depending on a behavior pattern of a user. Therefore, according to the advertisement delivery system of the present embodiment, even when an advertisement leading to the same landing page is displayed by the retargeting, a different display can be performed. Therefore, it is possible to suppress a fall in an advertising effectiveness caused by the repetition of the same advertisement. For example, it is possible to prevent the user from getting tired of repeated exposures. At the same time, it is possible to achieve high advertising effectiveness by prompting revisits to a landing page.

Further, according to the advertisement delivery system of the present embodiment, a message corresponding to a behavior pattern can be included in an advertisement, and therefore, the message can be effectively sent from an advertiser to a user.

Further, according to the advertisement delivery system of the present embodiment, a message corresponding to a response pattern to a questionnaire is included in an advertisement image, and therefore, it is possible to create pseudo-communication between a user responding to the questionnaire and an advertiser, and to guide the user to a new questionnaire. Hence, it is possible to collect more opinions from the user.

In addition, in the Web server 20 of the present embodiment, an advertisement image is registered in the advertisement database 252 in advance for each of possible behavior patterns, and therefore, it is possible to easily and rapidly extract an advertisement image to be displayed even when the behavior pattern is complicated.

### ——Examples of Delivered Advertisement——

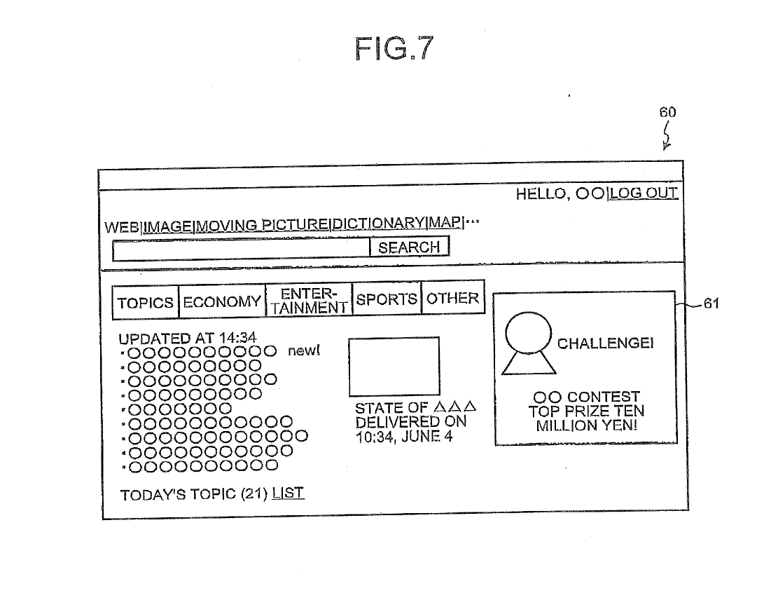

For example, assume that a user ID of an accessing user is “U001”, and it is determined in S501 that an advertisement of the advertisement ID “A0001” is delivered. The corresponding behavior pattern is “-” in the example illustrated in FIG. 5, “/image/ad001/000.jpg” is selected as a path of the advertisement image in the example illustrated in FIG. 4. FIG. 7 is a diagram illustrating an example of the screen 60 of the user terminal 10 on which a Web page is displayed. The screen 60 displays an advertisement 61. The advertisement 61 is an example of a result of displaying “/image/ad001/000.jpg”.

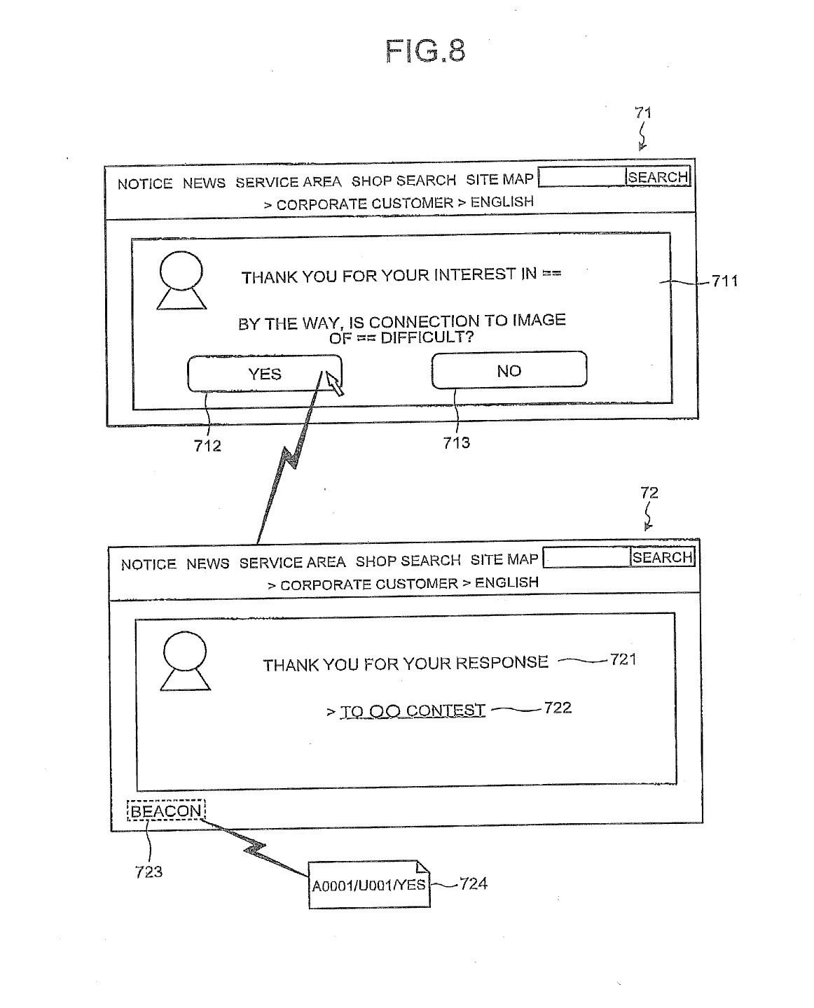

When the advertisement 61 is clicked on the screen 60, the user terminal 10 is redirected to a URL of a landing page by the HTTP processor 211 as described above, and the landing page is displayed. FIG. 8 is a diagram illustrating an example of the landing page provided by the LP providing server 30. A questionnaire 711 is displayed on a screen 71 of FIG. 8, and buttons 712 and 713 for inputting a response to the questionnaire 711 are disposed on the screen 71. When the button 712 on the screen 71 is pressed, the LP providing server 30 collects the questionnaire, and then transmits a Web page for displaying a screen 72 to the user terminal 10. A message 721 of thanks for the response to the questionnaire 711 and a link 722 to the previous contents are displayed on the screen 72.

A beacon 723 for transmitting the response to the questionnaire, that is, behavior of the user in the landing site to the Web server 20 is embedded in the screen 72. The beacon 723 is invisible in the screen 72, and is operated so as to transmit behavior information 724 including the advertisement ID indicating the advertisement, the user ID indicating the user accessing the landing page, and the behavior pattern indicating behavior of the user, to the Web server 20 from the user terminal 10. The beacon 723 may be a program described with a language such as JavaScript® or Java®.

The behavior information 724 which is transmitted by the user terminal 10 using the beacon 723 is received by the behavior pattern acquiring unit 214 of the Web server 20. The behavior pattern acquiring unit 214 updates a behavior pattern of the behavior pattern database 253 corresponding to the user ID and the advertisement ID included in the received behavior information, to the behavior pattern included in the behavior information. Thereby, the Web server 20 is notified of behavior information that a user of the user ID “U001” has taken a behavior pattern “YES” for the advertisement of the advertisement ID “A0001”. Therefore, when the user accesses the Web server 20 the next time, a behavior pattern corresponding to “A0001” and “U001” of FIG. 5 is updated to “YES”.

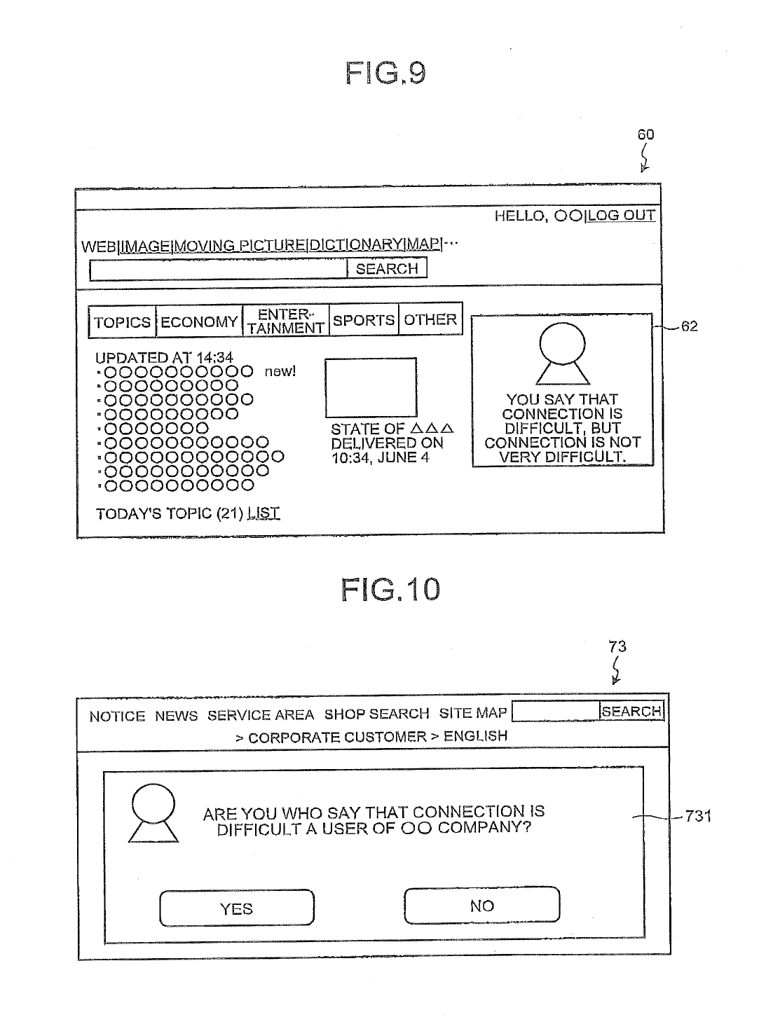

Here, if the user accesses the Web server 20 again, “/image/ad001/001.jpg” corresponding to “A0001” and “YES” of FIG. 4 is selected as a path of an advertisement image. FIG. 9 is a diagram illustrating an example of the screen 60 displayed when the user accesses the Web server 20 again. Thus, in the second access, when the delivery of the advertisement of “A0001” is determined, an advertisement 62 including a message for a response to the questionnaire 711 in the screen 71 of FIG. 8 is displayed instead of the advertisement 61. In this way, a message according to a behavior pattern in a landing site can be transmitted to a user.

In addition, a response pattern (behavior pattern) to a questionnaire is recorded for each user in the LP providing server 30 as well, and, if a landing page is revisited by retargeting, a different questionnaire is provided according to the response pattern to the questionnaire. FIG. 10 is a diagram illustrating an example of a questionnaire 131 displayed on a screen 73 when the advertisement 62 is clicked on the screen 60. Thus, the user revisits the landing page.

In this way, an advertisement displaying a message according to a response pattern (behavior pattern) to the questionnaire is displayed by the Web server 20, and a questionnaire is provided according to the behavior pattern by the LP providing server 30 as well, and thereby it is possible to conduct a questionnaire while performing pseudo-communication between a user and an advertiser.

### ——Modifications——

In the present embodiment, the Web server 20 and the LP providing server 30 are respectively a single computer, but, the present invention is not limited thereto, and they may be respectively realized by a plurality of computers. For example, a plurality of computers may virtually provide a single computer, and functions of the Web server 20 and the LP providing server 30 may be distributed to a plurality of computers or a plurality of virtual computers. For example, a storage unit may be realized as a database server independent from the Web server 20 and the LP providing server 30. In addition, the Web server 20 and the LP providing server 30 may be realized by a single virtual computer built by a single computer or a plurality of computers.

In addition, in a case where a plurality of Web servers 20 are provided, advertisement information and behavior pattern information may be synchronized between the Web servers 20 so as to build a so-called advertisement network in which an advertisement is delivered using the same algorithm.

Although, in the present embodiment, the Web server 20 determines an advertisement to be delivered, an advertisement delivery server which determines an advertisement to be delivered may be provided separately from the Web server 20. In this case, an advertisement may be delivered from the advertisement delivery server, or the advertisement delivery server determines an advertisement to be delivered and advertisement information may be delivered from the Web server 20.

In addition, although, in the present embodiment, an advertisement image is embedded in a Web page created by the Web page creating unit 212, for example, a frame for an advertisement space in which a predetermined URL for an advertisement is set by the Web page creating unit 222 may be included in a Web page and be transmitted to the user terminal 10, the user terminal 10 which displays the Web page including the frame may transmit an HTTP request for the URL for an advertisement, and, in response to the request, the advertisement delivery unit 213 may create an advertisement as a Web page described with HTML.

Further, although, in the present embodiment, an advertisement is embedded in a Web page as an image, the present invention is not limited thereto. The advertisement may be a character string, sound, a moving image, or the like. In a case where an advertisement is created using a character string, the advertisement database 252 may include message information where a character string is stored in association with an advertisement ID and a behavior pattern, instead of image information.

Further, although, in the present embodiment, one of the clicked advertisements is selected when a retargeting advertising is performed in step S502 of FIG. 6, clicked advertisements may be weighted such that the clicked advertisements are selected frequently, and then, an advertisement may be selected randomly.

In addition, although, in the present embodiment, an advertisement is randomly selected in step S503 of FIG. 6, selection of an advertisement may be performed using any method. For example, the advertisement delivery unit 213 may select advertisement information in a predetermined order, or may select advertisement information according to an attribute of a user.

Further, although, in the present embodiment, it has been assumed and described that only a single advertisement is displayed in a Web page, the present invention is not limited thereto, and retargeting may be performed for a plurality of advertisements. In this case, a plurality of pieces of advertisement information is selected in steps S502 and S503 of FIG. 6.

In addition, although, in the present embodiment, it is determined whether or not there is a clicked advertisement depending on whether or not behavior pattern information where a behavior pattern is “-” is registered in step S501 of FIG. 6, the present invention is not limited thereto, and, for example, when the HTTP processor 211 receives a request designating a redirect URL, a user ID and an advertisement ID may be recorded as a part of a log which indicates that an advertisement is clicked. Whether or not the advertisement is clicked may be determined depending on the presence/absence of a log.

Furthermore, in relation to the title of the advertisement information, different titles may be included in advertisement information depending on behavior patterns, and, in step S506 of FIG. 6, a title corresponding to a behavior pattern included in the advertisement information may be set as a title attribute of an image tag.

Further, although, in the present embodiment, an advertisement image is prepared for each of all the behavior patterns, for example, only one advertisement image in which a space for a message is provided and different messages depending on behavior patterns may be prepared, and, when an advertisement image is delivered, the Web server 20 may draw a message on the advertisement image.

Further, although, in the present embodiment, the beacon 723 is a program, for example, it may be a transparent image provided by the Web server 20. In this case, the LP providing server 30 sets an advertisement ID, a user ID, and a behavior pattern in a URL to the transparent image provided by the Web server 20 as parameters and thereby the Web server 20 may be notified of behavior information. In addition, parameters of a transparent image to a URL may be encoded.

Further, although, in the present embodiment, the user terminal 10 notifies the Web server 20 of behavior information using the beacon 723, the present invention is not limited thereto, and, a behavior pattern may be acquired from the LP providing server 30, or an input of a behavior pattern may be received from an operator of the Web server 20.

In addition, although, in the present embodiment, the beacon 723 is embedded in a Web page after a questionnaire is decompressed, for example, it may be embedded in the screen 72 displaying the questionnaire 711 as a program that determines which of the button 712 and 713 is pressed and transmits the behavior information 724 to the Web server 20.

Further, although, in the present embodiment, a response pattern to a questionnaire provided by the LP providing server 30 is a behavior pattern, the present invention is not limited thereto, and, various behavior patterns such as a purchase pattern, a viewing pattern, or a searched keyword pattern, may be employed as behavior patterns.

According to an embodiment of the present invention, it is possible to deliver an advertisement effectively through retargeting advertising.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An advertisement delivery apparatus which delivers an advertisement for causing a user terminal, which transmitted an access request to a web site via a link set in an advertisement, to transmit an access request to the web site again, the advertisement delivery apparatus comprising:
a behavior pattern acquiring unit that acquires a behavior pattern of the user terminal in the web site; and
an advertisement delivery unit that delivers to the user terminal a different advertisement depending on the behavior pattern by setting a link to the web site in the different advertisement.

2. The advertisement delivery apparatus according to claim 1, further comprising:
a storage unit that stores an advertisement corresponding to each behavior pattern of the user terminal in the web site,
wherein the advertisement delivery unit reads out an advertisement corresponding to the behavior pattern acquired by the behavior pattern acquiring unit from the storage unit, sets the link to the web site in the read advertisement, and delivers the advertisement.

3. The advertisement delivery apparatus according to claim 1, wherein a questionnaire is conducted in the web site,
the advertisement delivery apparatus further includes a storage unit that stores a different message from an advertiser corresponding to each response pattern to the questionnaire, and
the behavior pattern acquiring unit acquires a response pattern of the user terminal to the questionnaire.

4. An advertisement delivery method for delivering an advertisement for causing a user terminal, which transmitted an access request to a web site via a link set in an advertisement, to transmit an access request to the web site again, the advertisement delivery method comprising:
acquiring, by a computer, a behavior pattern of the user terminal in the web site; and
delivering to the user terminal, by the computer, a different advertisement depending on the behavior pattern by setting a link to the web site in the different advertisement.

5. A non-transitory computer readable storage medium containing program instructions for delivering an advertisement for causing a user terminal, which transmitted an access request to a web site via a link set in an advertisement, to transmit an access request to the web site again, wherein execution of the program instructions by one or more processors of a computer system causes the one or more processors to perform:
acquiring a behavior pattern of the user terminal in the web site; and
delivering to the user terminal a different advertisement depending on the behavior pattern by setting a link to the web site in the different advertisement.
